(19) United States
(12) Patent Application Publication
(10) Pub. No.: US 2015/0043788 A1
(43) Pub. Date: Feb. 12, 2015

(54) Determining and Validating a Posture of an Animal

(71) Applicant: ClicRweight, LLC, Tampa, FL (US)

(72) Inventor: Ken Lee, Fairfax, VA (US)

(21) Appl. No.: 14/336,624

(22) Filed: Jul. 21, 2014

Related U.S. Application Data
(60) Provisional application No. 61/857,012, filed on Jul. 22, 2013.

(51) Int. Cl. G06K 9/62; G06K 9/46; G06K 9/00; G06K 9/52

(52) U.S. Cl. CPC G06K 9/6202; G06K 9/52; G06K 9/4604; G06K 9/00201
USPC 382/110

(57) ABSTRACT

Described herein are methods and systems, including computer program products, for validating a posture of an animal. An imaging device captures at least one image of an animal, where each image includes a body region of the animal, and transmits the image to a computing device. The computing device generates a 3D point cloud based upon the image. The computing device performs one or more edge analysis tests on the 3D point cloud, and determines whether the posture is valid based upon the one or more edge analysis tests

### RELATED APPLICATIONS

This application claims priority to U.S. Provisional Patent Application No. 61/857,012, tiled on Jul. 22, 2013, the entirety of which is incorporated herein by reference.

### TECHNICAL FIELD

The subject matter of the application relates generally to livestock management, and more particularly to processes and systems, including computer program products, for determining and validating a posture of an animal.

### BACKGROUND

Characteristics such as weight and body condition score (BCS) ohm animal are useful to determine the productivity, re-production, health, and longevity of an animal, and techniques are being developed to determine an animal's weight and BCS via automated and computerized methods and systems. Some techniques involve obtaining an image of the animal, for example, in a feeding pen or stable, using an imaging device (e.g., camera, scanner) and using a computerized system to analyze the image and determine the animal's weight and/or BCS.

However, the animal's posture as captured by the imaging device is important to determining an accurate value for the weight and/or BCS. If the animal is positioned in an incorrect or flawed posture, then the system may be unable to determine its weight and/or BCS, or may return an incomplete or inaccurate value for the weight and/or BCS.

### SUMMARY

Therefore, what is needed is a computer vision system and corresponding methods that can be used to automate the determination and validation of an animal's posture to provide a lower cost, yet more reliable, measurement of the animal's weight and/or BCS.

The invention, in one aspect, features a method for validating a posture of an animal. An imaging device captures at least one image of an animal, where each image includes a body region of the animal, and transmits the image to a computing device. The computing device generates a 3D point cloud based upon the image. The computing device performs one or more edge analysis tests on the 3D point cloud, and determines whether the posture is valid based upon the one or more edge analysis tests,

The invention, in another aspect, features a system for validating a posture of an animal. The system includes an imaging device configured to capture at least one image of an animal, where each image includes a body region of the animal, and transmits the image to a computing device. The system includes a computing device configured to generate a 3D point cloud based upon the image, perform one or more edge analysis tests on the 3D point cloud, and determine whether the posture is valid based upon the one or more edge analysis tests.

Any of the above aspects can include one or more of the following features. Performing, one or more edge analysis tests includes generating a cubic polynomial curve based upon the topmost points of the 3D point cloud, and analyzing the inflection point and concavity of the cubic polynomial curve. Performing one or more edge analysis tests includes analyzing the local minimum and maximum of the cubic polynomial curve.

Performing one or more edge analysis tests includes generating a linear model based upon the topmost points of the 3D point cloud, and analyzing the slope, of the linear model. In some embodiments, the computing device determines that the posture is not valid if the slope of the linear model exceeds 0.12.

In some embodiments, each image includes a plurality of body regions. The image is a 3D scan. The body region is a rump, hip, backbone, thigh, short-rib, long-rib, tail-head, or pin bone of the animal. In sonic embodiments, a weight and/or a body condition score of the animal is determined using the image

Other aspects and advantages of the invention will become apparent from the following detailed description, taken in conjunction with the accompanying drawings, illustrating the principles of the invention by Way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for determining a posture of an animal based on analysis of at least one image of the animal.

FIG. 2. is a flow diagram of a method for determining a posture for an animal base on analysis of at least one image of the animal.

FIG. 3 is a detailed flow diagram of a method for determining, a posture for an animal based on analysis of at least one image of the animal.

FIG. 4 is a flow diagram of a method for validating the posture of the animal appearing the scan.

FIG. 5 is a diagram of an exemplary cubic polynomial curve model.

FIG. 6 is a diagram of an exemplary linear model.

FIG. 7 is a diagram of two different results produced by the computing device after conducting the linear model matching.

FIG. 8A is a diagram of an exemplary inflection point and concavity test on a cubic polynomial curve where the computing device determined that the inflection point and concavity measurements of the curve pass the test.

FIG. 8B is a diagram of an exemplary inflection point and concavity test on a cubic polynomial curve where the computing device 108 determined that the concavity measurements of the curve fail the test.

FIG. 8C is a diagram of an exemplary inflection point and concavity test on a cubic polynomial curve where the computing device determined that the inflection point measurements of the curve fail the test.

FIG. 9A is a diagram of an exemplary critical point test on a cubic. polynomial curve where the computing device determined that the curve has at least one critical point and that the local maximum and local minimum exist within the x range of the point cloud and the local maximum is higher than the local minimum, thereby passing the test.

FIG. 9B is a diagram of an exemplary critical point test on a cubic polynomial curve where the computing device determined that the curve does not have any critical points, thereby failing the test.

FIG. 9C is a diagram of an exemplary local minimum test on a cubic polynomial curve where the computing device determined that the local minimum of the curve falls outside the x range of the point cloud, thereby failing the test.

FIG. 10 is a diagram of exemplary body regions of an animal (e.g., a cow) to be identified by the computing device.

### DETAILED DESCRIPTION

The invention described herein features systems and methods for determining a posture of an animal, based on analysis of a 3D image of the animal which can be used to measure not just height, width, and depth of the animal but also the size of different body regions such as the rump or ribs, for instance.

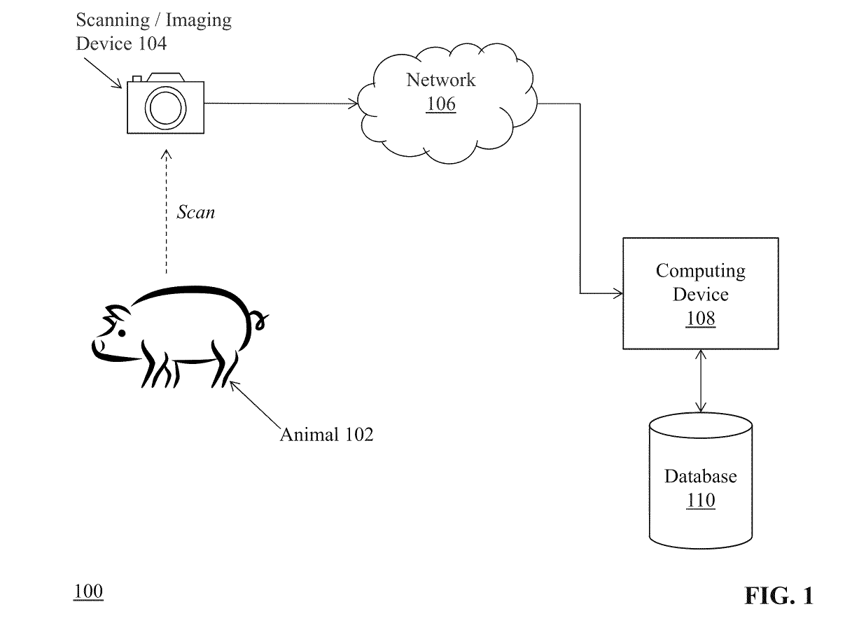

FIG. 1 is a block diagram of a system 100 for determining a posture for an animal based on analysis of at least one image of the animal. The system 100 includes an animal 102 (e.g., pig), a scanning/imaging device 104, a communications network 106, a computing device 108, and a database 110. The methods described herein may be achieved by implementing program procedures, modules and/or software executed on, for example, a processor based computing devices or network of computing devices.

The animal 102 is placed in proximity to the scanning/imaging device .104 so that the scanning imaging device 104 captures an image. or scan of the animal 102. While a pig is depicted in FIG. 1, it should be understood that other animals can be used within the scope of invention, including but not limited to cows, heifers, bulls, steers, pigs, hogs, sheep, goats, horses, other livestock, and/or dogs.

The imaging/scanning device 104 can be, e.g., a stereoscopic imaging device or an infrared camera. In some embodiments, multiple images of the animal are captured at one or more different angles. The imaging/scanning device 104 can include one or more filters, lenses or control mechanisms (e.g., auto-positioning, focusing or processing systems). The imaging/scanning device 104 can be a stereoscopic video camera, a 3D scanner, a charged coupled device, a photodiode array, as CMOS optical sensor, a still photographic camera, a digital camera, and/or a conventional two-dimension camera. Multiple imaging/scanning devices can be used in some embodiments.

In some embodiments, the imaging/scanning device 104 includes a light source for illuminating a field-of-view of the device. The light source can he a coherent source, such as a laser, or an incoherent source, such as a light emitting diode. The light source can be configured to illuminate a broadside of the animal or to backlight the animal. The light source can be a linear array, such as an array of monochromatic light emitting diodes (LEDs) with diffusers. In sonic embodiments, the imaging/scanning device 104 includes a depth sensor such as an infrared laser projector combined with a monochrome CMOS sensor, which captures video data in 3D under ambient light conditions.

In some embodiments, the invention can be implemented in a closed-ended chute including a control wall having an animal feeder, an animal presence indicator and an imaging device having a field-of-view substantially unobstructed by walls of the chute. The implementation can include a control system communicatively connected to the animal presence indicator and the imaging device, and configured to control the imaging device based upon information communicated by the animal presence indicator.

The communications network 106 transmits captured images and scans to the computing device 108. The network 106 may be a local network, such as a LAN, or a wide area network, such as the Internet or the World Wide Web. The network 106 may utilize cellular. satellite or other wireless communications technology, For example, the scanning/imaging device 104 may send and receive information via a communications link to a satellite, which in turn communicates with the computing device 108.

The computing device 108 receives the. captured images and scans from the scanning/imaging device 104 via the network 106. As will be described in greater detail below, the computing device 108 processes the images and scans to determine a posture of the animal. The computing device 108 communicates with a database 110 for retrieval of data for comparison with the received scans and for storage of determined posture data. In some embodiments, the computing device 108 is coupled to other computing devices (not shown). in some embodiments, the database 110 is internally integrated into the computing device 108. It should be appreciated that any number of computing devices, arranged in a variety of architectures, resources, and configurations (e.g., cluster computing, virtual computing, cloud computing) can be used without departing from the scope of the invention.

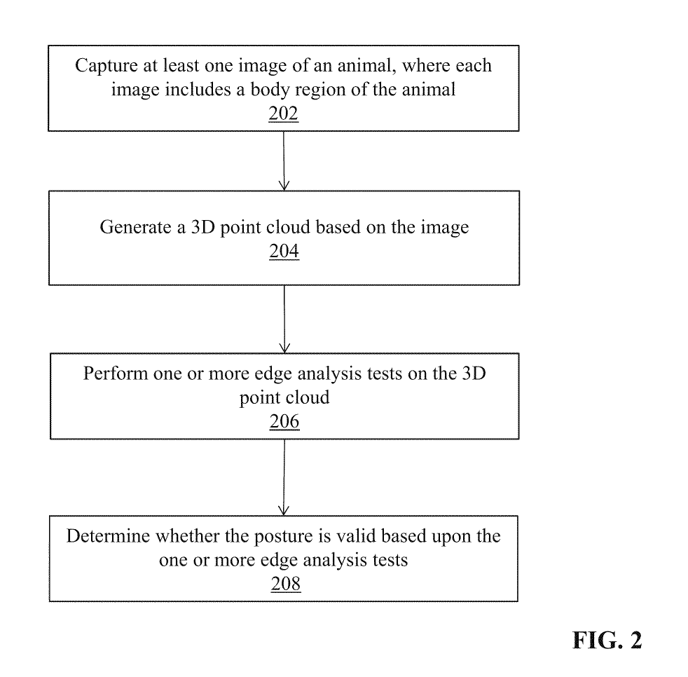

FIG. 2 is a flow diagram of a method for determining a posture of an animal based on analysis of at least one image or scan of the animal, using the system 100 of FIG. 1. The imaging/scanning device 104 captures (202) at least one image of an animal (e.g., animal 102), where the image includes a body region. In some embodiments, the imaging/scanning device 104 captures images of the animal from a plurality of different angles in order to accurately capture the shape of the animal.

The imaging/scanning device .104 transmits the captured image to the computing, device 108 via, the network 106. The computing, device 108 generates (204) a 3D point, cloud based on the captured image. The computing device 108 performs (206) one or more edge analysis tests on the 3D point cloud. The computing device (208) determines whether the animal's posture is valid based upon the one or more edge analysis tests.

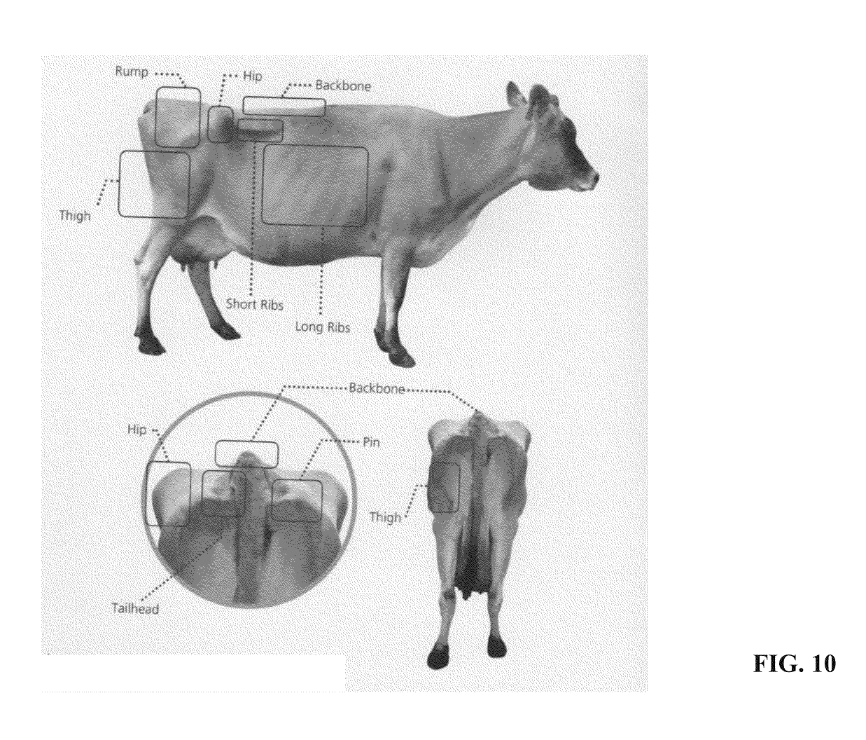

If the animal's posture is valid, the computing device 108 can perform additional analysis on the image and/or the 3D point cloud, including but not limited to cropping the image to isolate specific body parts or body regions of the animal (such as those depicted in FIG. 10) and comparing the cropped body regions to exemplary fitting models for the same body regions to determine certain features or characteristics of the animal, such as weight or body condition score (BCS). Techniques for determining the weight of an animal based upon an image of the animal are described in U.S. patent application Ser. No. 13/832,186, filed on Mar. 15, 2013 and titled “Methods and Systems for Determining and Displaying Animal Metrics,” is incorporated herein by reference.

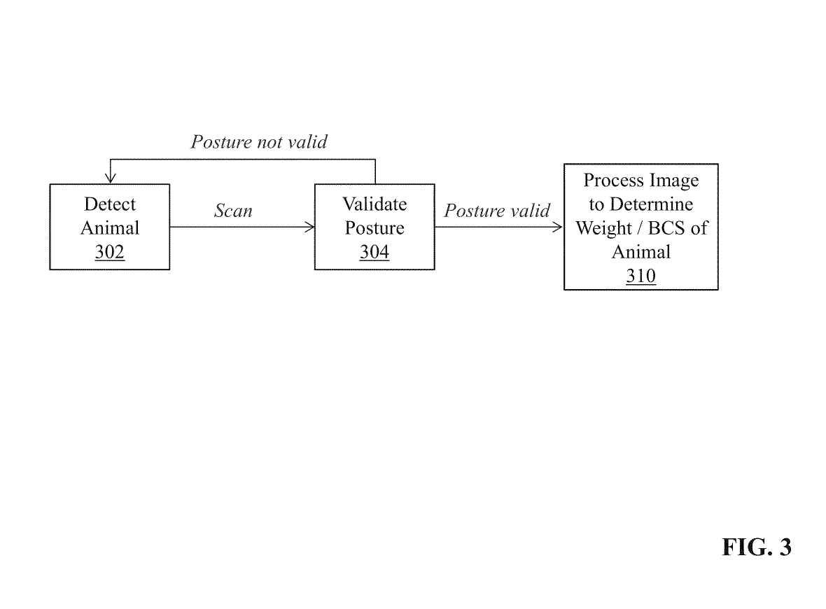

FIG. 3 is a detailed flow diagram of a method for determining, a posture of an animal based on analysis of at least one image of the animal, using the system 100 of FIG. 1.

The imaging/scanning device 104 is always on and continuously captures images and/or scans of a specific area (e.g., as feeding pen). In some embodiments, the scans are captured at ten frames per second.

The imaging/scanning device 104 transmits each scan to the computing device 108, and the computing device 108 analyzes the scan to detect (302) whether an animal is present in the scan. For example, the computing device 108 compares the currently-received scan against the previous scan to determine whether any new objects appear within the current scan, The computing device can subtract the previous scan from the current scan, or determine whether the number of points within the current scan reflects a significant change (i.e., a greater number of points). If the computing device 108 does not detect the presence of an object, the device 108 does not conduct any further processing on the received scan.

If a new object is detected, the computing device 108 then extracts the newly-detected object from the background of the current scan. For example, the computing device 108 can subtract the region of the scan around the background points from the current scan, leaving the new object. In another example, the computing device 108 can grab the points around the region where the animal is expected to appear or stand.

The computing device 108 then compares the newly-detected object to a fitting model retrieved from the database 110 to determine whether the object does or does not contain any background points. To accomplish the comparison, the computing device 108 can analyze the scan using a curve-fitting algorithm such as Random Sample Consensus (RANSAC), or by using an iterative closest point (ICP) algorithm and determining a minimum ICP error. It should he understood that other methods for comparing the object to a fitting model may be used without departing from the scope of invention.

If the computing device 108 detects the presence of an object (e.g., animal) in the scan, the computing device moves on to validate (304) the posture of the animal appearing in the scan. Determination of an accurate and consistent weight and/or BCS for an animal necessitates that the animal is in the proper posture when the imaging/scanning device captures an image. If the animal is not in a valid posture, then portions of the animal could be missing from the scan which would lead to an inaccurate or incomplete weight and/or BCS determination for the

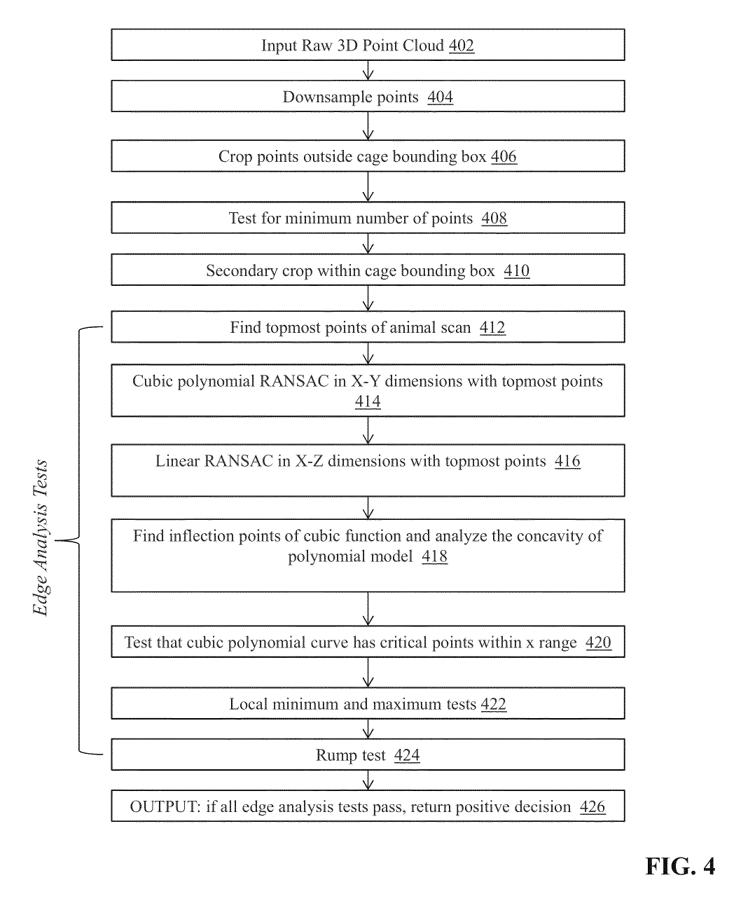

FIG. 4 is a flow diagram of a method for validating the posture of the animal appearing the scan. The computing device 108 receives as input (402) the raw 3D point cloud captured by the imaging/scanning device 104. For example, the raw point cloud can be in a .VDL file format. The computing device 108 also receives the position of the 3D cage, such as the ground and frame sides. In some embodiments, the 3D cage is not used but can help with processing efficiency and consistency. The computing device 108 then downsamples (404) the points in the raw 3D point cloud and crops (406) points outside the boundaries of the 3D cage bounding box to reduce the amount of background noise within the cage boundaries.

The computing device 108 tests (408) the number of points within the cage bounding box to determine whether the number of points exceeds as predetermined minimum value (e.g., to ensure that the scan density is sufficient), and performs a secondary crop (410) of points within the cage bounding box.

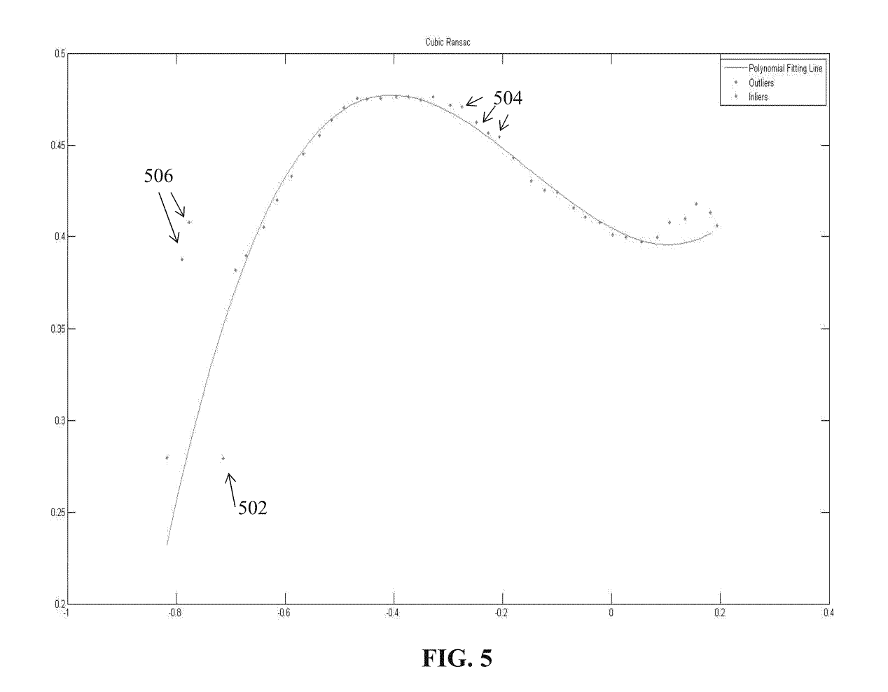

The computing device 108 finds (412) the topmost points of the scan and utilizes a RANSAC algorithm to perform a number of edge analysis tests on the scan (in both a side view and a top-down view) to determine whether the animal's posture is valid. The computing device 108 uses RANSAC to pick a random sample of four points to fit a cubic polynomial curve to (step 414). Then, the distance from the curve, to each point is calculated to find which points are hitters to the curve model. The cubic polynomial curve procedure is repeated a set number of times with the goal of reducing error, but in some instances the RANSAC algorithm may not reach a decision. In such cases, the algorithm generates an edge analysis error and produces a negative decision with respect to the animal's posture. FIG. 5 is a diagram of an exemplary cubic polynomial curve model generated by RANSAC. As shown in FIG. 5, many of the points (e.g., points 504) are close to the polynomial curve 502 and are deemed inliers, while other points (e.g., points 506) are further away from the curve 502 and are deemed outliers.

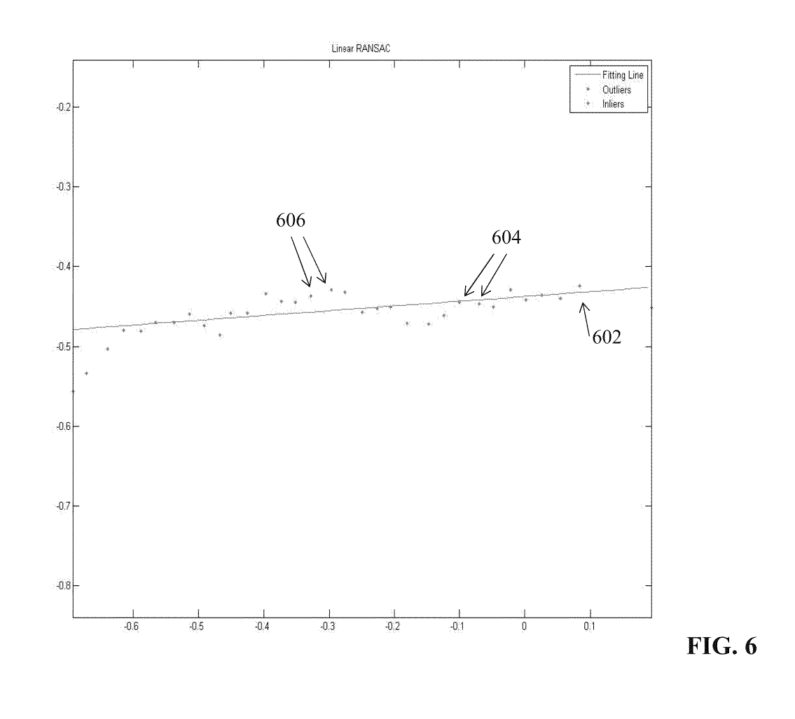

Returning to FIG. 4, the computing device 108 then uses RANSAC to match a “flat” linear model to the X-Z coordinates of the topmost points of the animal's back from a top-down perspective (step 416). A negative decision is automatically produced if the algorithm cannot produce a consensus for the procedure. FIG. 6 is a diagram of an exemplary linear model generated by RANSAC. As shown in FIG. 6, some of the points (e.g., points 604) are dose to the fitting line 602, and are deemed inliers. Some of the points (e.g., points 606) are father away from the fitting line 602, and are deemed outliers.

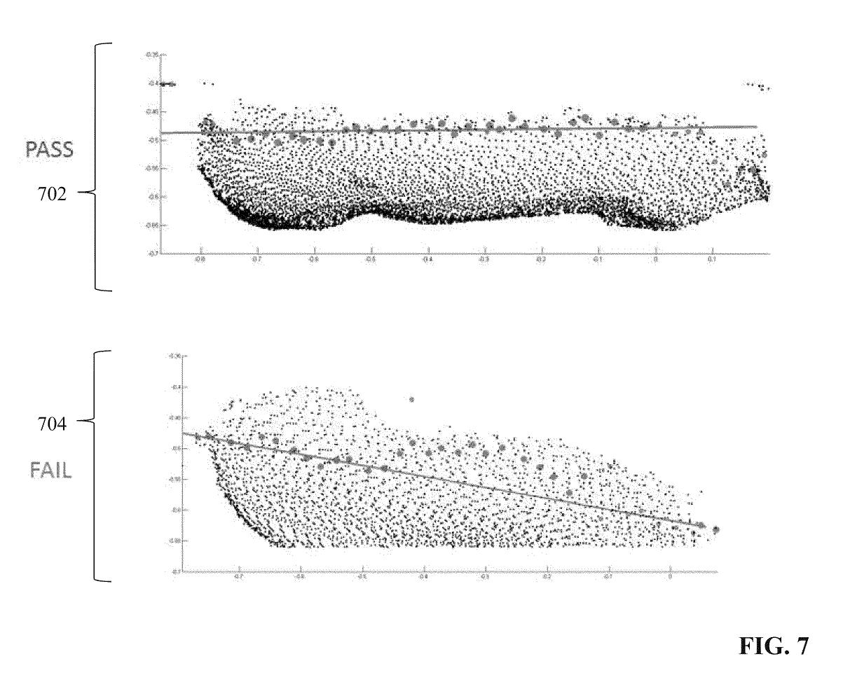

Also, the animal is classified by the algorithm as “bent” if the absolute value of the slope is greater than 0.12, resulting in a negative decision regarding the posture of the animal. FIG. 7 is a diagram of two different results produced by the computing device 108 after conducting the linear model matching. As shown in 702, the fitting line is nearly horizontal and therefore the animal's posture passes the linear model test. However, as shown in 704, the fitting line slopes downward from left to right, producing a failure of the linear model test.

Returning to FIG. 4, the computing device 108 finds (418) inflection points of the cubic polynomial curve and analyzes the concavity of the polynomial curve. These data points are important to determining the posture of an animal as, for example, a hog's back in an upright, standing position produces as back shape that first curves upward then downward.

As modeled by the cubic polynomial curve, the curvature of the topmost points must change within the range of the x values of the point cloud. The computing device 108 tests the value of the inflection point on the polynomial curve, which is where concavity of the curve changes. if the computing device 108 determines that the inflection point is outside of the x range for the point cloud, the computing device 108 returns an edge analysis error and a negative decision to capture as scan of the animal.

Next, the computing device 108 determines whether the concavity of the polynomial curve changes from being concave down on the left-hand side to being concave up on the right-hand side, which the change in concavity occurring at the inflection point. If this concavity change does not occur, then the animal's posture is not valid.

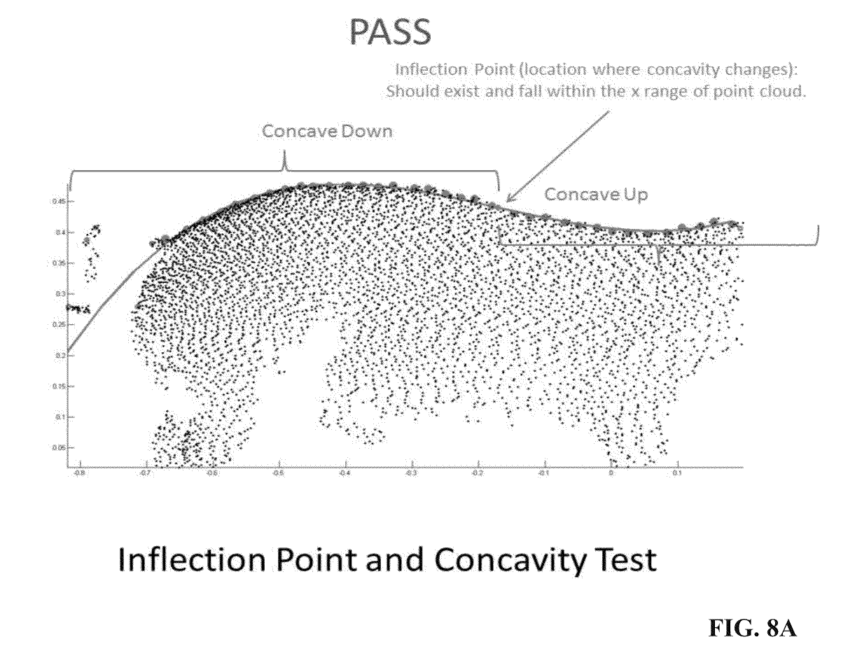

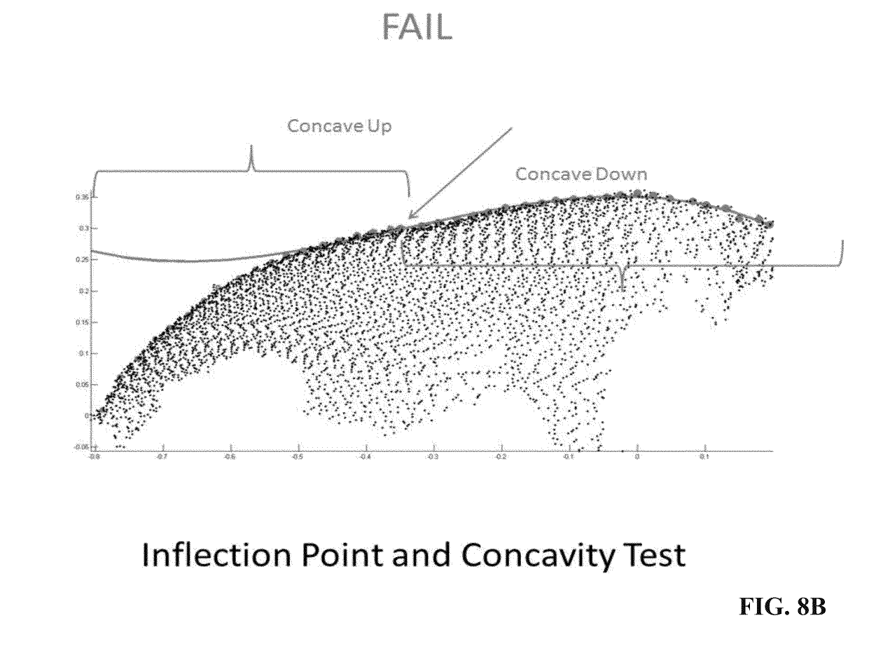

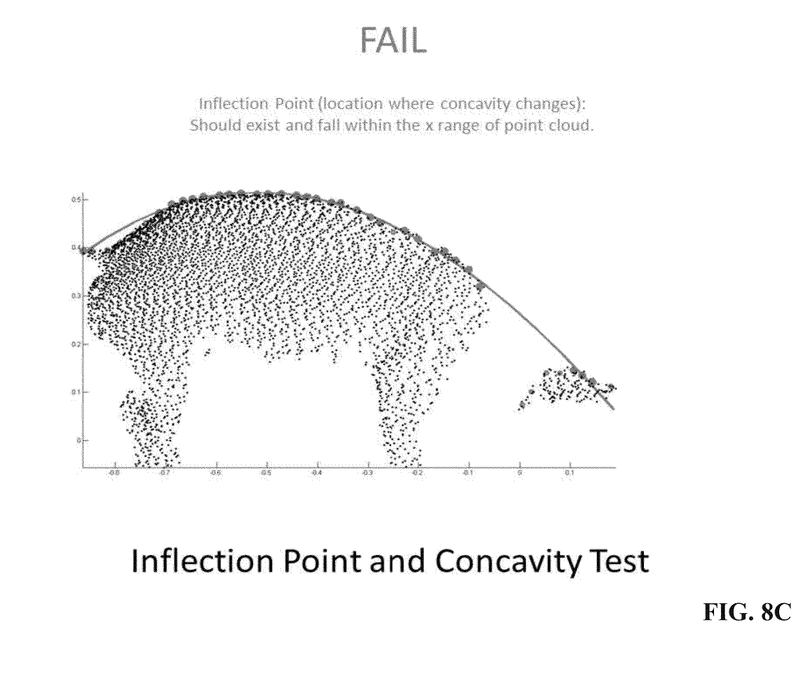

FIG. 8A is a diagram of an exemplary inflection point and concavity test on a cubic polynomial curve where the computing device 108 determined that the inflection point and concavity measurements of the curve pass the test. As shown in FIG. 8A, the inflection point falls within the x range of the point cloud and the left-hand side of the curve is concave down, while the right-hand side of the curve is concave up.

FIG. 8B is a diagram of an exemplary inflection point and concavity test on a cubic polynomial curve where the computing device 108 determined that the concavity measurements of the curve fail the test. As shown in FIG. 8B, although the inflection point falls within the x range of the point cloud, the curve is concave up on the left-hand side before the inflection point and is concave down on the right-hand side after the inflection point. FIG. 8C is a diagram of an exemplary inflection point and concavity test on a cubic polynomial curve where the computing device 108 determined that the inflection point measurements of the curve fail the test. As shown in FIG. 8C, an inflection point is missing from the curve.

Returning to FIG. 4, the computing device 108 then tests (420) the cubic polynomial curve to determine whether the curie has critical points within the x range of the point cloud. For example, the computing device 108 determines whether the curve includes at least one real critical point. Further, the curve should have only local maxima and minima at critical points, if the curve does not have such local maxima and minima, the cubic function is monotonic and the curve is not the desired shape (e.g., the animal is probably sitting down).

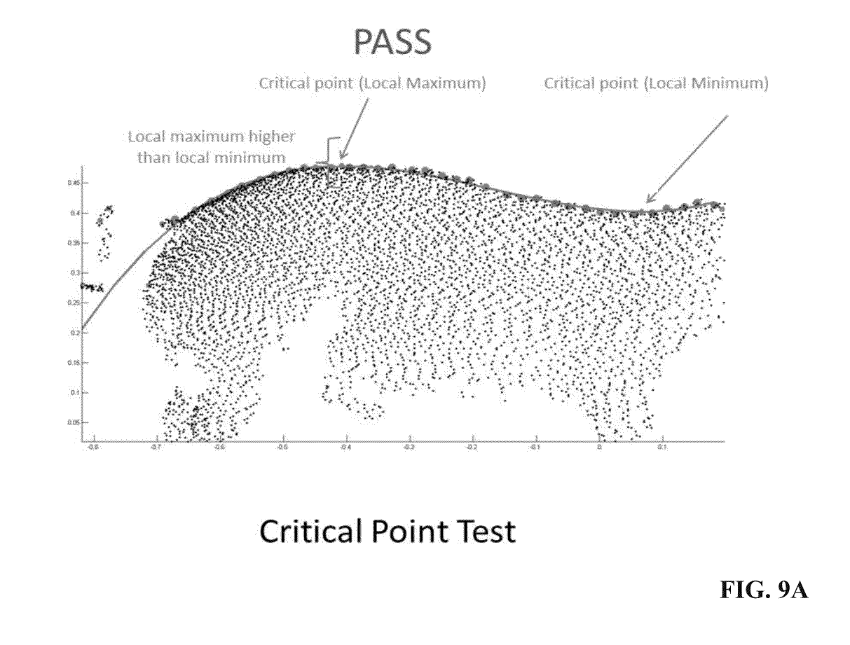

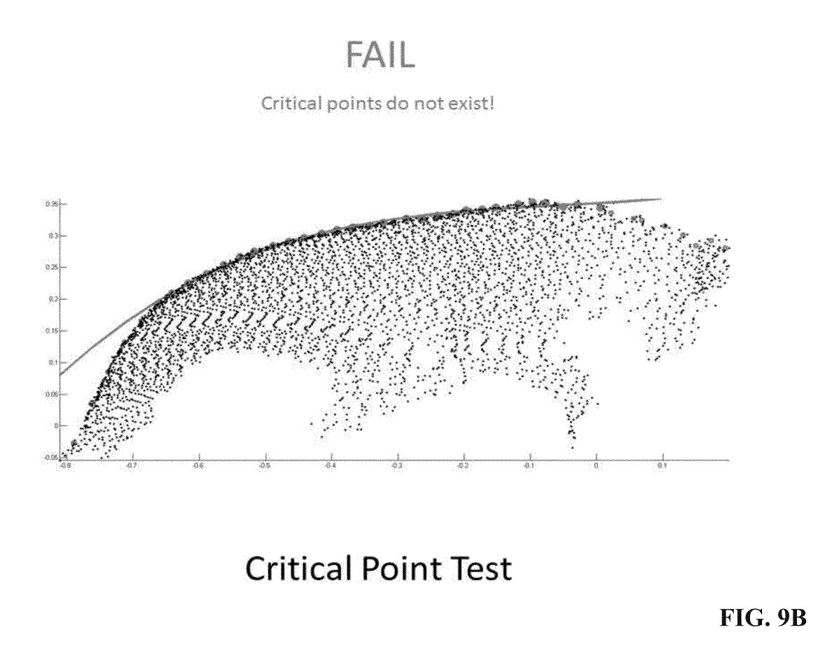

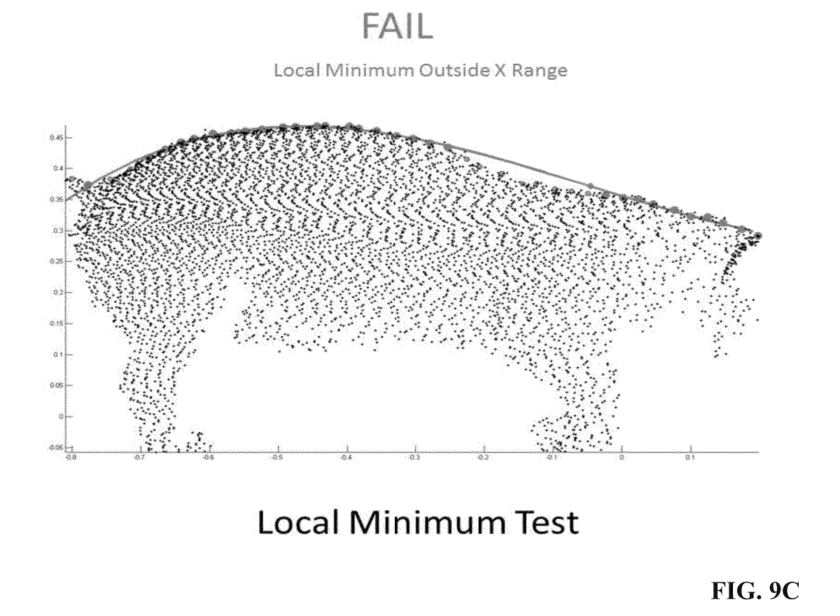

The computing device 108 then tests (422) the curve to determine whether the curve contains a local minimum/minima and a local maximum/maxima, and also whether the local maximum is higher than the local minimum. FIG. 9A is a diagram of an exemplary critical point test on a cubic polynomial curve where the computing device 108 determined that the curve has at least one critical point and that the local maximum and local minimum exist within the x range of the point cloud and the local maximum is higher than the local minimum, thereby passing the test. FIG. 9B is a diagram of an exemplary critical point test on a cubic polynomial curve where the computing device 108 determined that the curve does not have any critical points, thereby failing, the test. FIG. 9C is a diagram of an exemplary local minimum test on a cubic polynomial curve where the computing device 108 determined that the local minimum of the curve falls outside the x range of the point cloud, thereby failing the test.

Returning to FIG. 4, the computing device 108 tests (424) the cubic polynomial curve to determine whether the rump point of the curve (the lowest value, of the concave downward portion of the topmost points) is higher or lower than the neck point of the curve (the topmost value of the concave downward portion of the topmost points). If the rump point is lower than the neck point, then the test fails.

If the computing device 108 determines positive or passing values for each of the tests in steps 412 through 424, then the computing device 108 concludes that the posture of the animal in the scan is valid and instructs the imaging/scanning device 104 to capture the scan. If the computing device 108 determines a negative or failing value for any of the tests in steps 412 through 424, then the computing device 108 concludes that the posture of the animal is not valid and does not capture the scan.

Once the posture validation procedure is complete and the posture of the animal in the scan has been verified, the computing device 108 can then further analyze the 3D point cloud and/or image to determine (310) the overall BCS value for the animal. There are many techniques within the scope of the invention that can be used to determine additional characteristics of the animal, such as the overall weight or the overall HCS value of the animal.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, fur example, be a programmable processor, a computer, and/or multiple computers.

A computer program can be written in any farm of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the technology by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks magneto-optical disks CD-ROM and/or DVD-ROM disks, The processor and the memory can be supplemented by, and/or incorporated in special purpose logic circuitry.

To provide for interaction with a user, the above, described techniques can be implemented on a computer having a display device, a transmitting device, and/or a computing device. The display device can be, for example, a cathode ray tube (CRT) and/or a liquid crystal display (LCD) monitor. The interaction with as user can he, for example, a display of information to the user and a keyboard and a pointing device (e.g., a mouse or a trackball) by which the user can provide input to the computer (e.g., interact with a user interface element). Other kinds of devices can be used to provide for interaction with a user, Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, tablet) with a world wide web browser (e.g., Microsoft® Internet Explorer® available from Microsoft Corporation, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation. Apache Web Server available from Apache Software Foundation, Apache Tomcat Web Server available from Apache Software Foundation).

The storage module can be, for example, a random access memory (RAM) module, a read only memory (ROM) module, as computer hard drive, a memory card (e.g., universal serial bus (USB) flash drive, a secure digital (SD) flash card), a floppy disk, and/or any other data storage device, information stored on a storage module can be maintained, for example, in a database (e.g., relational database system, flat database system) and/or any other logical information storage mechanism.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN). the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific illustrative embodiments, it should be understood that various changes in form and detail may be made without departing from the scope described herein.

What is claimed is:

1. A method for validating a posture of an animal, the method comprising:
capturing, by an imaging device, at least one image of an animal, wherein each image includes a body region of the animal, and transmitting the image to a computing device;
generating, by the computing device, a 3D point cloud based upon the image;
performing, by the computing device, one or more edge analysis tests on the 3D point cloud; and
determining, by the computing device, whether the posture is valid based upon the one or more edge analysis tests.

2. The method of claim 1. wherein performing one or more edge analysis tests includes:
generating a cubic polynomial curve based upon the topmost points of the 3D point cloud; and
analyzing the inflection point and concavity of the cubic polynomial curve.

3. The method of claim 2, further comprising analyzing the local minimum and maximum of the cubic polynomial curve

4. The method of claim 1. wherein performing one or more edge analysis tests includes:
generating a linear model. based upon the topmost points of the 3D point cloud; and
analyzing the slope of the linear model.

5. The method of claim 4, wherein the computing device determines that the posture is not valid if the slope of the linear model exceeds 0.12.

6. The method of claim 1, wherein each image includes a plurality of body regions.

7. The method of claim 1, wherein the image is a 3D scan.

8. The method of claim 1, wherein the body region is a rump, hip, backbone, thigh, short-rib, long-rib, tail-head, or pin bone or the animal.

9. The method of claim 1, further comprising determining a weight and/or a BCS of the animal based upon the image.

10. A system for validating a posture of an animal, the system comprising:
an imaging device configured to capture at least one image of an animal, wherein each image includes a body region of the animal, and transmit the image to a computing device;
the computing device configured to:
generate a 3D point cloud based upon the image;
perform one or more edge analysis tests on the 3D point cloud; and
determine whether the posture is valid based upon the one or more edge analysis tests.

11. The system of claim 10, wherein performing one or more edge analysis tests includes:
generating a cubic polynomial curve based upon the topmost points of the 3D point cloud; and
analyzing the inflection point and concavity of the cubic polynomial curve.

12. The system of claim the computing device further configured to analyze the local minimum and maximum of the cubic polynomial curve.

13. The system of claim 10, wherein performing one or more edge analysis tests includes:
generating a linear model based upon the topmost points of the 3D point cloud; and
analyzing the slope of the linear model.

14. The system of claim 13, wherein the computing device determines that the posture is not valid if the slope of the linear model exceeds 0.12.

15. The system of claim 10, wherein each image includes a plurality of body regions.

16. The system of claim 10, wherein the image is a 3D scan.

17. The system of claim 10, wherein the body region is a rump, hip, backbone, thigh, short-rib, long-rib, tail-head, or pin bone of the animal.

18. The system of claim 10, wherein the computing device is further configured to determine a weight and/or a BCS of the animal based upon the image.
